(19) United States
(12) Patent Application Publication
(10) Pub. No.: US 2025/0202984 A1
(43) Pub. Date: Jun. 19, 2025

(54) NEIGHBOR DATA MANAGEMENT

(71) Applicant: RAKUTEN SYMPHONY, INC., Tokyo (JP)

(72) Inventors: Abhishek SINGH, San Mateo, CA (US); Akash GUPTA, Indore (IN); Aaditya DHARAMPURIKAR, Indore (IN); Anurag MAHAJAN, Indore (IN); Rahul GUPTA, Indore (IN)

(73) Assignee: RAKUTEN SYMPHONY, INC., Tokyo (JP)

(21) Appl. No.: 18/541,011

(22) Filed: Dec. 15, 2023

(51) Int. Cl. H04L 67/133; H04L 67/75

(52) U.S. Cl. CPC H04L 67/133; H04L 67/75

(57) ABSTRACT

Provided are apparatus, method, and device for managing network neighbor data. According to embodiments, the method may be configured to: receiving, by a configuration manager, updated data of one or more neighboring cells in a telecommunications network; saving, by the configuration manager, the updated data into persistent storage; displaying, by the configuration manager, the updated data in a graphical user interface (GUI); and receiving, by the configuration manager, a first instruction to change a configuration in the one or more neighboring cells.

### 1. FIELD

Systems and methods consistent with example embodiments of the present disclosure relate to providing a method for managing neighbor data in telecommunications networks.

### 2. DESCRIPTION OF RELATED ART

In a telecommunications network, information regarding multiple neighboring cells may be shared within the network. Such neighbor information may be shared by a user equipment (UE) to a network, and it is essential to ensure that such sharing of information is performed smoothly without any loss of data.

### SUMMARY

According to embodiments, a method is provided. The method may include: receiving, by a configuration manager, updated data of one or more neighboring cells in a telecommunications network; saving, by the configuration manager, the updated data into persistent storage; displaying, by the configuration manager, the updated data in a graphical user interface (GUI); and receiving, by the configuration manager, a first instruction to change a configuration in the one or more neighboring cells.

According to embodiments, an apparatus is provided. The apparatus may be configured to: receive updated data of one or more neighboring cells in a telecommunications network; save the updated data into persistent storage; display the updated data in a graphical user interface (GUI); and receive a first instruction to change a configuration in the one or more neighboring cells.

According to embodiments, a non-transitory computer-readable recording medium is provided. The non-transitory computer-readable recording medium may have recorded thereon instructions executable by an apparatus to cause the apparatus to perform a method including: receiving updated data of one or more neighboring cells in a telecommunications network; saving the updated data into persistent storage; displaying the updated data in a graphical user interface (GUI); and receiving a first instruction to change a configuration in the one or more neighboring cells.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates a block diagram illustrating an example method for obtaining updated neighbor data using a configuration manager, and updating the parameters/configuration according to an embodiment;

FIG. 2 illustrates an example parameter view table which may be displayed in a GUI, according to an embodiment;

FIG. 3 illustrates an example change preview table which may be displayed in a GUI, according to an embodiment;

FIG. 4 is a diagram of an example environment in which systems and/or methods, described herein, may be implemented; and

FIG. 5 is a diagram of example components of a device according to an embodiment.

### DETAILED DESCRIPTION

The following detailed description of example embodiments refers to the accompanying drawings.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

As described above, in the related art, neighbor information may be shared by a user equipment (UE) to a network. However, if there is any issue with the transmission, or a reset occurs, the network neighbor information will be lost during reconfiguration, since there is no backup mechanism. Since there is no management of neighbor information, real time update support cannot be provided. Further, in the related art, there is no user interface (UI) which can be utilized to visualize neighbor parameters. Accordingly, there is also no means of displaying and managing a table, which contains a unified format of all parameters of neighbors, which could indicate relations between neighbors in the related art.

Accordingly, there is a need for a system which can capture neighbor information and for managing, visualizing, and updating neighbor parameters

Example embodiments of the present disclosure provide a method for managing configuration data for neighboring cells in a telecommunications network. According to an example method, the method may include receiving updated data of one or more neighboring cells in said telecommunications network, saving the updated data into storage (e.g., persistent storage such as a database), displaying the updated data in a form which can be visualized by a user (e.g., a graphical user interface (GUI), and receiving an instruction to change a configuration in one of the neighboring cells. The method may be implemented using a configuration manager. According to some embodiments, upon receiving the instruction, the configuration manager may be configured to update the configuration of the neighboring cells based on the instruction.

Accordingly, an automated system for managing the network neighbor data can be achieved.

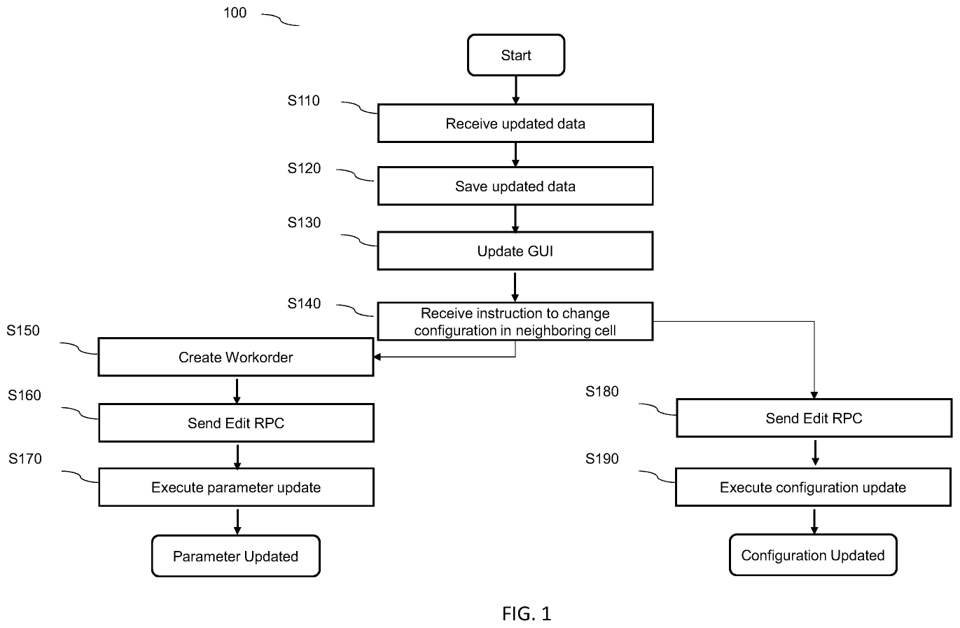

FIG. 1 illustrates a block diagram illustrating an example method 100 for obtaining updated neighbor data using a configuration manager, and updating the parameters/configuration according to an embodiment.

Referring to FIG. 1, at operation S110, updated data of one or more neighboring cells in a telecommunications network may be obtained by a configuration manager module (which may simply be referred to as “configuration manager” hereinafter). The configuration manager may include, or have access to a netconf controller which can connect to a netconf server. The configuration manager may have a user interface in some embodiments. According to some embodiments, the user interface may more specifically be a graphical user interface (GUI) According to embodiments, the neighboring cells may be eNodeB or gNodeB, nevertheless, it should be appreciated that this may depend on what telecommunications network is being utilized. The neighboring cells may implement network functions using eNodeB or gNodeB.

According to an embodiment, the updated data of one or more neighboring cells may originally be provided from a user equipment (UE) to a base station (e.g., eNodeB or gNodeB). The base station may then share the information with the configuration manager using a netconf interface. Specifically, the base station may have a netconf server, and a notification may be sent from a netconf server to a netconf controller (client), wherein the notification contains the updated data. The updated data may comprise one of deleting a neighbor cell, adding a neighbor cell, or updating a value of the one or more neighboring cells.

Referring back to FIG. 1, at operation S120, the updated data may be saved into storage. According to some embodiments, this may be persistent storage (such as, but not limited to, a database). It should be appreciated that a variety of data structures may be used for storing the updated data. For example, a table may be used.

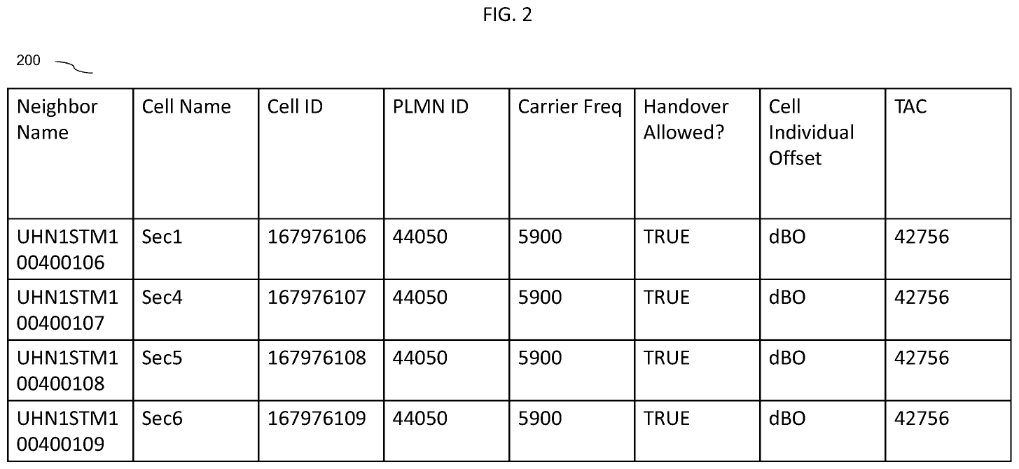

At operation S130, a GUI in the configuration manager may be updated based on the updated data. According to embodiments, the GUI may initially include a network tree view where the user can initially see all connected network elements. According to embodiments, the user may need to select a specific network element which they may wish to view (e.g., a vCU/gNodeB). In 5G, this may be selecting a CU-CP. For example, all available network elements may be displayed to the user, in a tabular format, or as a collapsible list, nevertheless it is contemplated that other methods for displaying the list of network elements to the user may be implemented. According to embodiments, once the user selects a specific network element, all the network components (NRT) associated with the network element, and all neighboring cell information parameters may be displayed. For example, this may be displayed in a tabular format, such (as exemplified in FIG. 2), nevertheless, it is contemplated that other methods for displaying the list of NRTs and neighboring information may be included.

Neighboring cell information parameters which may be displayed include, but is not limited to, a neighbor name, a cell name, a cell identifier, a public land mobile network (PLMN) ID, a carrier frequency, a physical cell ID, a Neighbor eNodeB ID, a tracking area code (TAC), a Neighbor Type value, a handover allowed parameter, a Cell Individual Offset, a Measurement Object Offset Frequency, and rank.

According to embodiments, the user may be able to interact with the listed information parameters of the neighboring cells. For example, the table may only display a summary of the data, and selecting the summary may open a pop-up window to show details regarding the data entry. The user may be able to interact with the listed information parameter to edit the data entry (e.g., an edit text box or a dropdown box may be displayed).

Since netconf may be an automated process to fetch the updated data (as discussed in operation S110), it should be appreciated that the GUI may be updated in real time.

At operation S140, an instruction to change the configuration in a neighboring cell may be received. This may be an instruction which is received by the user. For example, if the user interacts with the GUI to edit a parameter (for example, changing a handover allowed parameter from true to false), an instruction to update the respective parameter in the neighboring cell may be generated by the configuration manager. In the case that only a single parameter is being updated, operations S150-S170 may be executed, as illustrated in FIG. 1. Alternatively, if a complete configuration change/reset/re-initialization of the neighboring cells is instructed, operations S180-S190 may be executed.

At operation S150, a workorder may be generated based on the instruction in operation S140. The workorder may contain the details of the changes in parameter. The workorder may include a scheduling window. In particular, the scheduling window may allow the parameter to be updated automatically during the time indicated in the scheduling window. The user may set the scheduling window when editing the parameter in the GUI, or it may be automatically generated. It should be appreciated that in some embodiments, the exact time may be selected as the scheduling window.

According to some embodiments, the workorder may need to be approved by an authorized user prior to the change/parameter modification being executed. In particular, the authorized user may be a system administrator who needs to check that the changes in the workorder are appropriate, or may not cause any inadvertent network issues.

Referring back to FIG. 1, at operation S160, an edit RPC notification may be created by the configuration manager using the netconf controller, which may specify the parameter which needs to be changed.

At operation S170, the edit RPC notification may be sent from the netconf controller to the netconf server in the neighboring cell. Once the netconf server receives the edit RPC notification, the parameter may be updated in the neighboring cell. Accordingly, the parameter may be automatically updated based on receiving the instruction.

Operation S180 may be substantially similar with operation S160, in that an edit RPC notification may be created by the configuration manager using the netconf controller, with the primary difference being that the contents of the edit RPC notification may contain the entire configuration.

Operation S190 may be substantially similar with operation S170, in that the edit RPC notification may be sent from the netconf controller to the netconf server in the neighboring cell, with the primary difference that once the netconf server receives the edit RPC notification, the entire configuration is received in the neighboring cell. Accordingly, the neighboring cell can be completely changed/reset/reinitialized.

Accordingly, system, methods, devices, and the like, provided in the example embodiments of the present disclosure may automatically manage the network neighbor data, while avoiding data loss and providing real-time update support.

FIG. 2 illustrates an example parameter view table 200 which may be displayed in a GUI, according to an embodiment.

Table 200 may be displayed in a GUI and updated (based on operation S130). As seen in table 200, parameters of neighbor name, cell name, cell id, plmn id, carrier frequency, handover allowed value, cell individual offset, and TAC may be displayed for each network component (NRT). According to some embodiments, the user may be able to interact with each individual data entry in the table. For example, if the user clicks on “167976106”, the user may be able to see a detailed view of that NRT corresponding to the cell id. According to some embodiments, the user may be able to edit the fields in the data entry in the table in order to initialize editing a parameter. For example, if the user clicks on “TRUE” with regards to “Handover Allowed” in the second row, a pop-up box may appear to allow the user to change this value to “FALSE”. In other embodiments, other methods such as, but not limited to, a drop-down box, a toggle slider, a textbox, or a button may be used.

It is contemplated that the table may also include suggested values for modifying the parameters. According to embodiments, integration with a self-organizing network (SON) algorithm may be implemented in order to improve detecting values for network parameters and based on suggested values for parameters, changes may be performed and pushed to the neighboring cells so that table 200 may be updated. From SON itself based on the suggested changes, physical-cell-identity (PCI) conflicts and root-sequence-index (RSI) conflicts can be resolved. For example, SON may provide output as PCI and RSI suggested by algorithm to change for a particular site.

It is contemplated that according to some embodiments, additional features for the GUI may be implemented, such as adding a search bar to allow the user to filter and find specific network components or parameters.

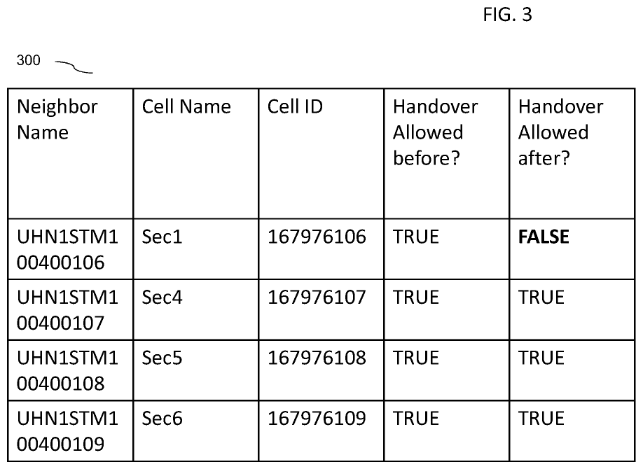

FIG. 3 illustrates an example change preview table 300 which may be displayed in a GUI, according to an embodiment.

FIG. 3 shows the same 4 NRT's which were shown in table 200, but only displays the neighbor name, cell name, cell id, the value of “Handover Allowed” before the change, and after the change. In this case, the user has opted to change the value of “Handover Allowed” in the first network component (e.g., the second row) from “TRUE” to “FALSE”. This may allow the user to visualize and confirm the changes prior to creating an instruction to edit the parameter. According to some embodiments, the changed portion may be emphasized (for example, by highlighting or changing the font) in order to allow the user to more easily visualize the changed portions only.

Change preview table 300 may be generated after the user opts to change a value in Table 200. According to some embodiments where a workorder needs to be created, the user may be allowed to select the scheduling window after confirming the changes in change preview table 300.

The above embodiments can accordingly automate the entire network neighbor data managing process, from capturing neighbor parameters to populating the GUI. If there is any configuration re-push/reset, all the neighbor information will be provided to the network. Any addition, deletion, or modification notifications may come from the network and be received by the configuration manager, and thus the configuration manager can automatically update the database. If there are any changes made in the configuration manager (via the GUI), changes may be updated via a workorder (with a scheduling window). Thus, an automated system for managing the network neighbor data can be achieved.

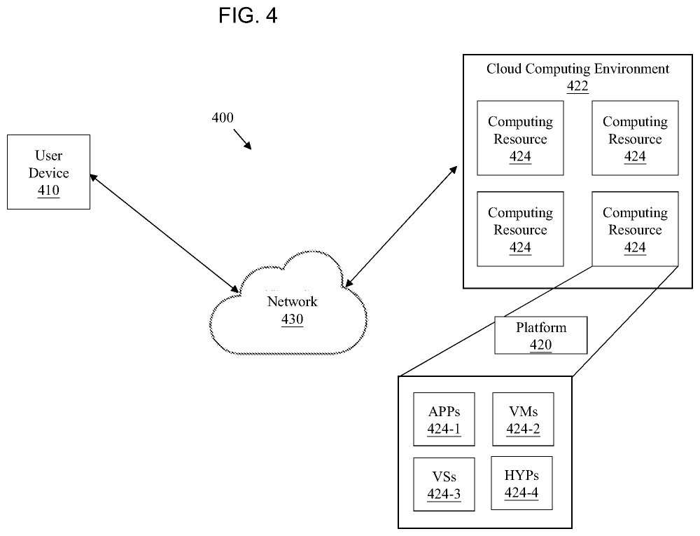

FIG. 4 is a diagram of an example environment 400 in which systems and/or methods, described herein, may be implemented. As shown in FIG. 4, environment 400 may include a user device 410, a platform 420, and a network 430. Devices of environment 400 may interconnect via wired connections, wireless connections, or a combination of wired and wireless connections. In embodiments, any of the functions and operations described with reference to FIGS. 1 through 3 above may be performed by any combination of elements illustrated in FIG. 4.

User device 410 includes one or more devices capable of receiving, generating, storing, processing, and/or providing information associated with platform 420. For example, user device 410 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 410 may receive information from and/or transmit information to platform 420.

Platform 420 includes one or more devices capable of receiving, generating, storing, processing, and/or providing information. In some implementations, platform 420 may include a cloud server or a group of cloud servers. In some implementations, platform 420 may be designed to be modular such that certain software components may be swapped in or out depending on a particular need. As such, platform 420 may be easily and/or quickly reconfigured for different uses.

In some implementations, as shown, platform 420 may be hosted in cloud computing environment 422. Notably, while implementations described herein describe platform 420 as being hosted in cloud computing environment 422, in some implementations, platform 420 may not be cloud-based (i.e., may be implemented outside of a cloud computing environment) or may be partially cloud-based.

Cloud computing environment 422 includes an environment that hosts platform 420. Cloud computing environment 422 may provide computation, software, data access, storage, etc., services that do not require end-user (e.g., user device 410) knowledge of a physical location and configuration of system(s) and/or device(s) that hosts platform 420. As shown, cloud computing environment 422 may include a group of computing resources 424 (referred to collectively as “computing resources 424” and individually as “computing resource 424”).

Computing resource 424 includes one or more personal computers, a cluster of computing devices, workstation computers, server devices, or other types of computation and/or communication devices. In some implementations, computing resource 424 may host platform 420. The cloud resources may include compute instances executing in computing resource 424, storage devices provided in computing resource 424, data transfer devices provided by computing resource 424, etc. In some implementations, computing resource 424 may communicate with other computing resources 424 via wired connections, wireless connections, or a combination of wired and wireless connections.

As further shown in FIG. 4, computing resource 424 includes a group of cloud resources, such as one or more applications (“APPs”) 424-1, one or more virtual machines (“VMs”) 424-2, virtualized storage (“VSs”) 424-3, one or more hypervisors (“HYPs”) 424-4, or the like.

Application 424-1 includes one or more software applications that may be provided to or accessed by user device 410. Application 424-1 may eliminate a need to install and execute the software applications on user device 410. For example, application 424-1 may include software associated with platform 420 and/or any other software capable of being provided via cloud computing environment 422. In some implementations, one application 424-1 may send/receive information to/from one or more other applications 424-1, via virtual machine 424-2.

Virtual machine 424-2 includes a software implementation of a machine (e.g., a computer) that executes programs like a physical machine. Virtual machine 424-2 may be either a system virtual machine or a process virtual machine, depending upon use and degree of correspondence to any real machine by virtual machine 424-2. A system virtual machine may provide a complete system platform that supports execution of a complete operating system (“OS”). A process virtual machine may execute a single program, and may support a single process. In some implementations, virtual machine 424-2 may execute on behalf of a user (e.g., user device 410), and may manage infrastructure of cloud computing environment 422, such as data management, synchronization, or long-duration data transfers.

Virtualized storage 424-3 includes one or more storage systems and/or one or more devices that use virtualization techniques within the storage systems or devices of computing resource 424. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 424-4 may provide hardware virtualization techniques that allow multiple operating systems (e.g., “guest operating systems”) to execute concurrently on a host computer, such as computing resource 424. Hypervisor 424-4 may present a virtual operating platform to the guest operating systems, and may manage the execution of the guest operating systems. Multiple instances of a variety of operating systems may share virtualized hardware resources.

Network 430 includes one or more wired and/or wireless networks. For example, network 430 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

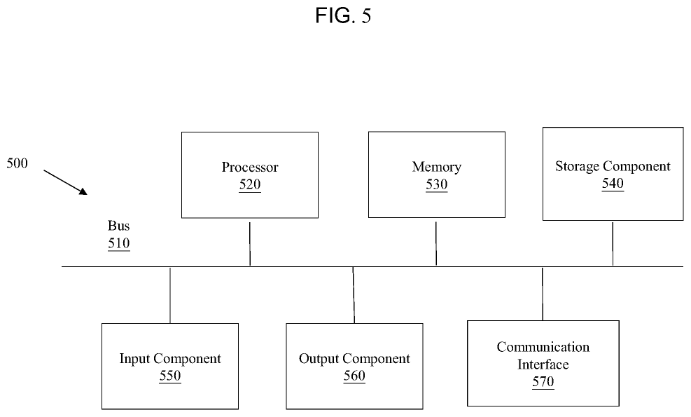

FIG. 5 is a diagram of example components of a device 500. Device 500 may correspond to user device 410 and/or platform 420. As shown in FIG. 5, device 500 may include a bus 510, a processor 520, a memory 530, a storage component 540, an input component 550, an output component 560, and a communication interface 570.

Bus 510 includes a component that permits communication among the components of device 500. Processor 520 may be implemented in hardware, firmware, or a combination of hardware and software. Processor 520 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 550 includes a component that permits device 500 to receive information, such as via user input (e.g., a touch screen display, a keyboard, a keypad, a mouse, a button, a switch, and/or a microphone). Additionally, or alternatively, input component 550 may include a sensor for sensing information (e.g., a global positioning system (GPS) component, an accelerometer, a gyroscope, and/or an actuator). Output component 560 includes a component that provides output information from device 500 (e.g., a display, a speaker, and/or one or more light-emitting diodes (LEDs)).

Communication interface 570 includes a transceiver-like component (e.g., a transceiver and/or a separate receiver and transmitter) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, or the like.

Device 500 may perform one or more processes described herein. Device 500 may perform these processes in response to processor 520 executing software instructions stored by a non-transitory computer-readable medium, such as memory 530 and/or storage component 540. A computer-readable medium is defined herein as a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

In embodiments, any one of the operations or processes of FIGS. 1-3 may be implemented by or using any one of the elements illustrated in FIGS. 4 and 5. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

### Various Aspects of Embodiments

Various further respective aspects and features of embodiments of the present disclosure may be defined by the following items:

Item [1]: A method that may include: receiving, by a configuration manager, updated data of one or more neighboring cells in a telecommunications network; saving, by the configuration manager, the updated data into persistent storage; displaying, by the configuration manager, the updated data in a graphical user interface (GUI); and receiving, by the configuration manager, a first instruction to change a configuration in the one or more neighboring cells.
Item [2] The method according to item [1], wherein the updated data may be provided by a user equipment (UE) to a base station, and the updated data may be received from the base station via a notification from a netconf server.
Item [3] The method according to any one of items [1]-[2], wherein the instruction to change a configuration may be to update a parameter in the one or more neighboring cells, and wherein upon receiving the instruction, the method may further include: creating, by the configuration manager, a workorder having a scheduling window; and sending, by the configuration manager, an edit remote procedure call (RPC) to a netconf server during the scheduling window, wherein upon receiving the edit RPC, the netconf server may update the parameter in the one or more neighboring cells.
Item [4] The method according to item [3], wherein the workorder may be approved by an authorized user prior to sending the edit RPC.
Item [5] The method according to any one of items [1]-[2], wherein the instruction to change a configuration may be to reset the one or more neighboring cells, and wherein upon receiving the instruction, the method may further include: sending, by the configuration manager, an edit remote procedure call (RPC) to a netconf server, wherein upon receiving the edit RPC, the netconf server may update the configuration in the one or more neighboring cells.
Item [6] The method according to any one of items [1]-[5], wherein the updated data may include one of deleting a neighbor cell, adding a neighbor cell, or updating a value of the one or more neighboring cells.
Item [7] The method according to any one of items [1]-[6], wherein the configuration may include one or more parameters of: a neighbor name, a cell name, a cell identifier, a public land mobile network (PLMN) ID, a carrier frequency, a physical cell ID, a Neighbor eNodeB ID, a tracking area code (TAC), a Neighbor Type value, a handover allowed parameter, a Cell Individual Offset, a Measurement Object Offset Frequency, and rank.
Item [8] An apparatus that may be configured to: receive updated data of one or more neighboring cells in a telecommunications network; save the updated data into persistent storage; display the updated data in a graphical user interface (GUI); and receive a first instruction to change a configuration in the one or more neighboring cells.
Item [9] The apparatus according to item [8], wherein the updated data may be provided by a user equipment (UE) to a base station, and the updated data may be received from the base station via a notification from a netconf server.
Item [10] The apparatus according to any one of items [8]-[9], wherein the instruction to change a configuration may be to update a parameter in the one or more neighboring cells, and wherein upon receiving the instruction, the apparatus may be further configured to: create a workorder having a scheduling window; and send an edit remote procedure call (RPC) to a netconf server during the scheduling window, wherein upon receiving the edit RPC, the netconf server may update the parameter in the one or more neighboring cells.
Item [11] The apparatus according to item [10], wherein the workorder may be approved by an authorized user prior to sending the edit RPC.
Item [12] The apparatus according to any one of items [8]-[9], wherein the instruction to change a configuration may be to reset the one or more neighboring cells, and wherein upon receiving the instruction, the apparatus may be further configured to: send an edit remote procedure call (RPC) to a netconf server, wherein upon receiving the edit RPC, the netconf server may update the configuration in the one or more neighboring cells.
Item [13] The apparatus according to any one of items [8]-[12], wherein the updated data may include one of deleting a neighbor cell, adding a neighbor cell, or updating a value of the one or more neighboring cells.
Item [14] The apparatus according to any one of items [8]-[13], wherein the configuration may include one or more parameters of: a neighbor name, a cell name, a cell identifier, a public land mobile network (PLMN) ID, a carrier frequency, a physical cell ID, a Neighbor eNodeB ID, a tracking area code (TAC), a Neighbor Type value, a handover allowed parameter, a Cell Individual Offset, a Measurement Object Offset Frequency, and rank.
Item [15]: A non-transitory computer-readable recording medium that may have recorded thereon instructions executable by an apparatus to cause the apparatus to perform a method including: receiving updated data of one or more neighboring cells in a telecommunications network; saving the updated data into persistent storage; displaying the updated data in a graphical user interface (GUI); and receiving a first instruction to change a configuration in the one or more neighboring cells.
Item [16] The non-transitory computer-readable recording medium according to item [15], wherein the updated data may be provided by a user equipment (UE) to a base station, and the updated data may be received from the base station via a notification from a netconf server.
Item [17] The non-transitory computer-readable recording medium according to any one of items [15]-[16], wherein the instruction to change a configuration may be to update a parameter in the one or more neighboring cells, and wherein upon receiving the instruction, the method may further include: creating a workorder having a scheduling window; and sending an edit remote procedure call (RPC) to a netconf server during the scheduling window, wherein upon receiving the edit RPC, the netconf server may update the parameter in the one or more neighboring cells.
Item [18] The non-transitory computer-readable recording medium according to item [17], wherein the workorder may be approved by an authorized user prior to sending the edit RPC.
Item [19] The non-transitory computer-readable recording medium according to any one of items [15]-[16], wherein the instruction to change a configuration may be to reset the one or more neighboring cells, and wherein upon receiving the instruction, the method may further include: sending, by the configuration manager, an edit remote procedure call (RPC) to a netconf server, wherein upon receiving the edit RPC, the netconf server may update the configuration in the one or more neighboring cells.
Item [20] The non-transitory computer-readable recording medium according to any one of items [15]-[19], wherein the updated data may include one of deleting a neighbor cell, adding a neighbor cell, or updating a value of the one or more neighboring cells.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method comprising:
receiving, by a configuration manager, updated data of one or more neighboring cells in a telecommunications network;
saving, by the configuration manager, the updated data into persistent storage;
displaying, by the configuration manager, the updated data in a graphical user interface (GUI); and
receiving, by the configuration manager, a first instruction to change a configuration in the one or more neighboring cells.

2. The method as claimed in claim 1, wherein the updated data is provided by a user equipment (UE) to a base station, and the updated data is received from the base station via a notification from a netconf server.

3. The method as claimed in claim 1, wherein the instruction to change a configuration is to update a parameter in the one or more neighboring cells, and wherein upon receiving the instruction, the method further comprises:
creating, by the configuration manager, a workorder having a scheduling window; and
sending, by the configuration manager, an edit remote procedure call (RPC) to a netconf server during the scheduling window, wherein upon receiving the edit RPC, the netconf server updates the parameter in the one or more neighboring cells.

4. The method as claimed in claim 3, wherein the workorder may be approved by an authorized user prior to sending the edit RPC.

5. The method as claimed in claim 1, wherein the instruction to change a configuration is to reset the one or more neighboring cells, and wherein upon receiving the instruction, the method further comprises:
sending, by the configuration manager, an edit remote procedure call (RPC) to a netconf server, wherein upon receiving the edit RPC, the netconf server updates the configuration in the one or more neighboring cells.

6. The method as claimed in claim 1, wherein the updated data comprises one of deleting a neighbor cell, adding a neighbor cell, or updating a value of the one or more neighboring cells.

7. The method as claimed in claim 1, wherein the configuration may include one or more parameters of: a neighbor name, a cell name, a cell identifier, a public land mobile network (PLMN) ID, a carrier frequency, a physical cell ID, a Neighbor eNodeB ID, a tracking area code (TAC), a Neighbor Type value, a handover allowed parameter, a Cell Individual Offset, a Measurement Object Offset Frequency, and rank.

8. An apparatus configured to:
receive updated data of one or more neighboring cells in a telecommunications network;
save the updated data into persistent storage;
display the updated data in a graphical user interface (GUI); and
receive a first instruction to change a configuration in the one or more neighboring cells.

9. The apparatus as claimed in claim 8, wherein the updated data is provided by a user equipment (UE) to a base station, and the updated data is received from the base station via a notification from a netconf server.

10. The apparatus as claimed in claim 8, wherein the instruction to change a configuration is to update a parameter in the one or more neighboring cells, and wherein upon receiving the instruction, the apparatus is further configured to:
create a workorder having a scheduling window; and
send an edit remote procedure call (RPC) to a netconf server during the scheduling window, wherein upon receiving the edit RPC, the netconf server updates the parameter in the one or more neighboring cells.

11. The apparatus as claimed in claim 10, wherein the workorder may be approved by an authorized user prior to sending the edit RPC.

12. The apparatus as claimed in claim 8, wherein the instruction to change a configuration is to reset the one or more neighboring cells, and wherein upon receiving the instruction, the apparatus is further configured to:
send edit remote procedure call (RPC) to a netconf server, wherein upon receiving the edit RPC, the netconf server updates the configuration in the one or more neighboring cells.

13. The apparatus as claimed in claim 8, wherein the updated data comprises one of deleting a neighbor cell, adding a neighbor cell, or updating a value of the one or more neighboring cells.

14. The apparatus as claimed in claim 8, wherein the configuration may include one or more parameters of: a neighbor name, a cell name, a cell identifier, a public land mobile network (PLMN) ID, a carrier frequency, a physical cell ID, a Neighbor eNodeB ID, a tracking area code (TAC), a Neighbor Type value, a handover allowed parameter, a Cell Individual Offset, a Measurement Object Offset Frequency, and rank.

15. A non-transitory computer-readable recording medium having recorded thereon instructions executable by an apparatus to cause the apparatus to perform a method comprising:
receiving updated data of one or more neighboring cells in a telecommunications network;
saving the updated data into persistent storage;
displaying the updated data in a graphical user interface (GUI); and
receiving a first instruction to change a configuration in the one or more neighboring cells.

16. The non-transitory computer-readable recording medium as claimed in claim 15, wherein the updated data is provided by a user equipment (UE) to a base station, and the updated data is received from the base station via a notification from a netconf server.

17. The non-transitory computer-readable recording medium as claimed in claim 15, wherein the instruction to change a configuration is to update a parameter in the one or more neighboring cells, and wherein upon receiving the instruction, the method further comprises:
creating a workorder having a scheduling window; and
sending an edit remote procedure call (RPC) to a netconf server during the scheduling window, wherein upon receiving the edit RPC, the netconf server updates the parameter in the one or more neighboring cells.

18. The non-transitory computer-readable recording medium as claimed in claim 17, wherein the workorder may be approved by an authorized user prior to sending the edit RPC.

19. The non-transitory computer-readable recording medium as claimed in claim 15, wherein the instruction to change a configuration is to reset the one or more neighboring cells, and wherein upon receiving the instruction, the method further comprises:
sending an edit remote procedure call (RPC) to a netconf server, wherein upon receiving the edit RPC, the netconf server updates the configuration in the one or more neighboring cells.

20. The non-transitory computer-readable recording medium as claimed in claim 15, wherein the updated data comprises one of deleting a neighbor cell, adding a neighbor cell, or updating a value of the one or more neighboring cells.
